(19) United States
(12) Patent Application Publication
(10) Pub. No.: US 2017/0054264 A1
(43) Pub. Date: Feb. 23, 2017

(54) Socket-assembly and the method of manufacturing

(71) Applicants: C2WIDE Co., LTD., Seoul (KR); JCMICRO, Kamina Gun (JP)

(72) Inventors: DuckSu RYU, Anyang-si (KR); Toshiyuki NAKAMURA, Nagano-ken (JP)

(21) Appl. No.: 15/241,651

(22) Filed: Aug. 19, 2016

(30) Foreign Application Priority Data
Aug. 20, 2015 (KR) 10-2015-0117406

(51) Int. Cl. H01R 43/20

(52) U.S. Cl. CPC H01R 43/205

(57) ABSTRACT

One-piece socket with aforementioned structure and manufacturing solves the problems of two-pieces socket. Such one-piece socket can be made thinner than two-pieces socket, making it possible to be used as CPU socket of products like notebooks, where exiting two-pieces socket couldn't be used. Also, as one-piece socket is more appealing in terms of price, it can also enter burn-in test market, where price is a determining factor.

### TECHNICAL FIELD

A probe pin manufactured by stamping technique is inserted into a pin hole of an one-piece socket. Through applying heat and punching to area around the hole where the probe pin is inserted, it is made sure that the probe pin will not fall out of the hole.

### BACKGROUND ART

Existing semiconductor test socket is manufactured in the form of two pieces, top and bottom piece. Top and bottom piece each has stepped pulley inside pin hole and probe pin will stay between two pin holes.

### SUMMARY OF INVENTION

### Technical Problem

Due to its standard structure of two-pieces socket, costs of production are high and it is difficult to make socket that is thinner than 2 mm. Consequently, due to high price of two-pieces socket, two-pieces sockets are not compatible for semiconductor products, such as system semiconductor, that require burn-in test. Also, they are not compatible for thin products, such as notebooks and laptops, as thin sockets of about 1 mm are needed to be able to use detachable CPU.

The invention is intended for eliminating the problems of existing two-pieces socket. It aims at providing very thin one-piece socket with probe pins inserted at lower price by manufacturing socket in one piece and probe pin that is shorter than 2 mm.

Despite the advantages of spring probe pin, existing spring probe pin cannot be used for burn-in test due to high price of spring probe pin. One-piece socket can resolve this problem as a result of lower costs of production. Also, it is intended for providing very thin socket with spring probe pin inserted inside to be used for notebooks or laptops, enabling them to have detachable CPU.

### Solution to Problem

The most important aspect of manufacturing one-piece socket is transforming the edge of the pin hole by applying heat or using mechanical method to make sure that the probe pin doesn't fall out of the pin hole. When this is overdone, the probe pin will not be able move inside the hole. Similarly, when it is not done enough, the probe pin will fall out of the hole easily. Also, one socket contains decades or thousands of pin holes and the edge of every single hole has to be processed identically. If one pin hole has defect, the socket cannot be used.

In order to process all the holes identically, bumps are formed around the edge of pin hole. Probe pin is then inserted, certain degree of heat is applied to the bumps, and several stages of punching are applied to the bumps. This allows part of the bump to fall into the pin hole, covering enough area of the pin hole to make sure that the probe pin stays inside the hole without having any problem in its movement.

Another method other than forming bumps around pin hole is applying heat and punching to the surrounding area of the pin hole so that enough amount of the materials fall into the hole, latch enough area of the hole.

In order to make suitable probe pin for one-piece socket, thin metal board is rolled by automated stamping process to make probe pin with same function and efficiency of spring probe pin. As such probe pin is processed reel to reel, completed pins will be situated at constant pitch. Since the pins are situated at constant pitch, automatic machine can insert the pins into the holes of one-piece socket and also apply punching and heat around the pin holes at the same time, forming bumps around the pin holes and latch the pin holes.

### Advantageous Effects of Invention

Using mentioned manufacturing methods, one-piece socket can be made and such sockets can be used for price sensitive burn-in test and CPU socket of notebooks.

### BRIEF DESCRIPTION OF DRAWINGS

FIG. 1 is a cross section of one-piece socket assembly.

FIG. 2 is a detailed blueprint of probe pin.

FIG. 3 is a blueprint of another method of manufacturing probe pin.

FIG. 4 is a completed probe pin rolled into cylindrical shape.

FIG. 5 is a cross section showing ongoing test commenced by contact between socket and IC chip.

FIG. 6 is a step by step manufacturing method of socket assembly.

FIG. 7 is an illustration showing process of heat and punching transforming bump and latch surrounding area of pin hole.

### DESCRIPTION OF EMBODIMENTS

As there could be different variations and various designs for the invention, specific examples will be discussed followed by detailed explanation and drawings.

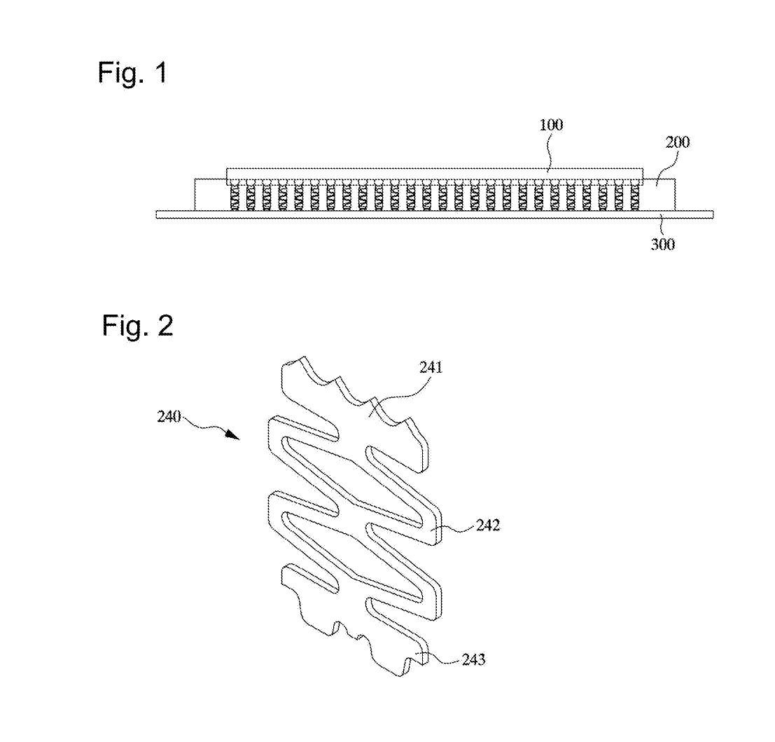

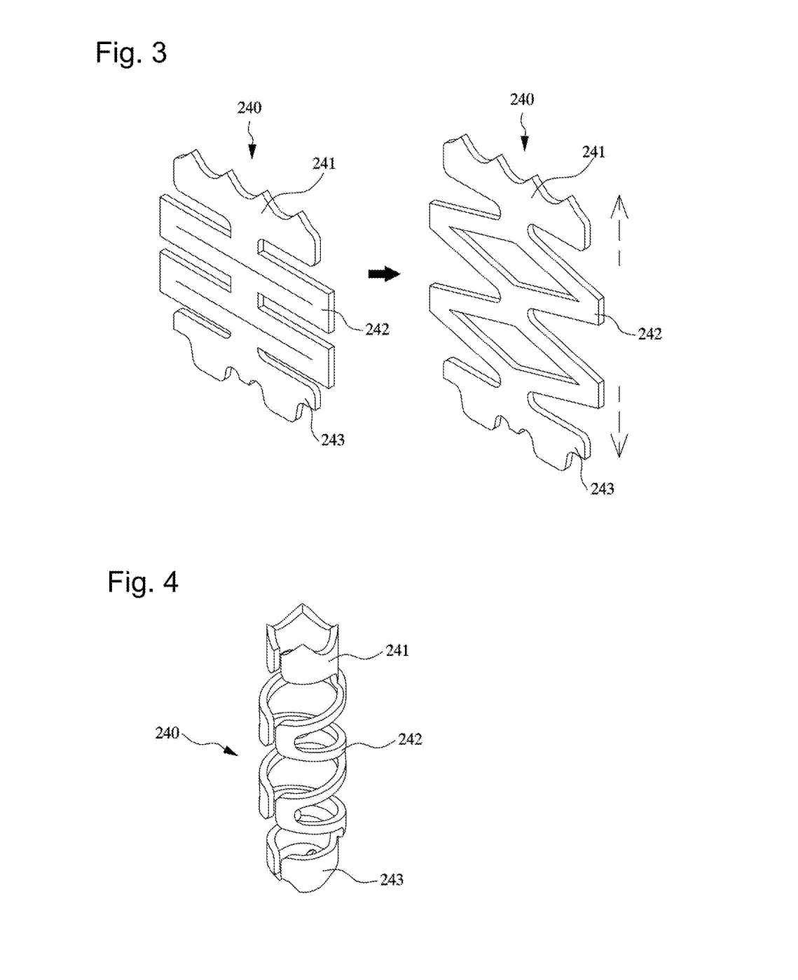

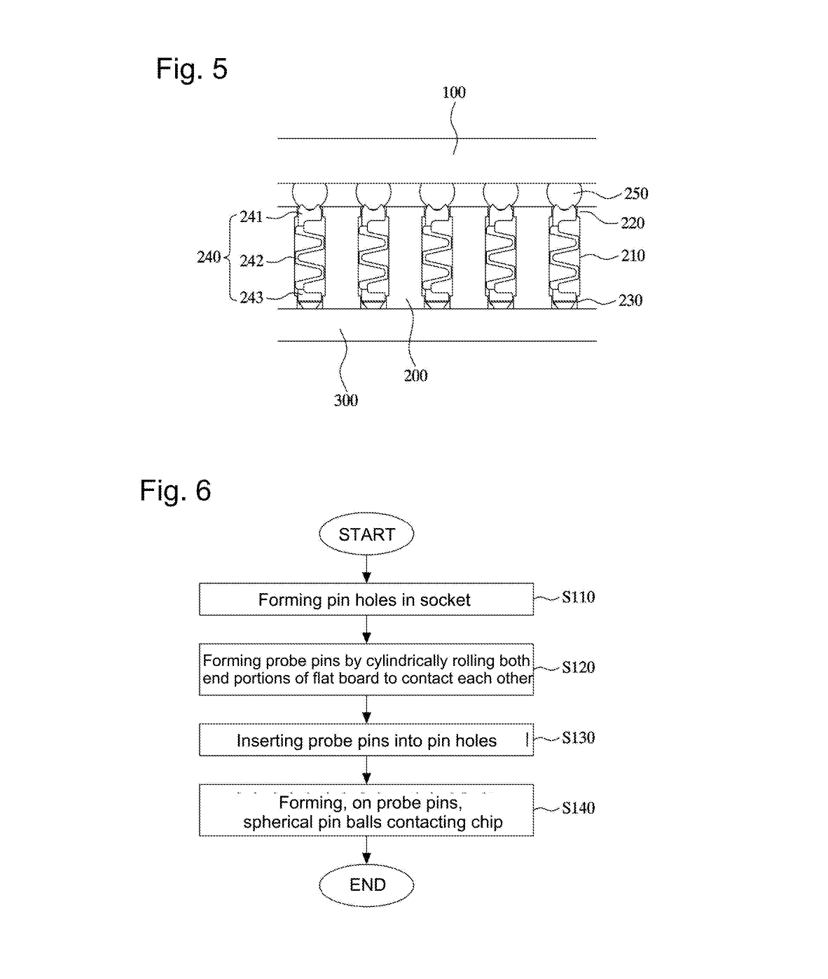

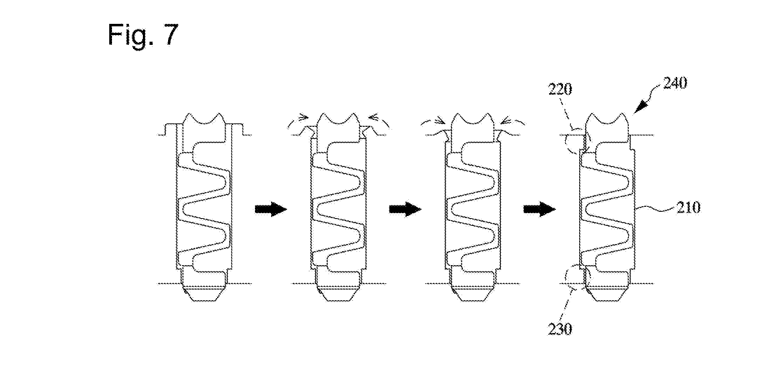

FIG. 1 is the cross section of one-piece socket, FIG. 2 the detailed blueprint of probe pin, FIG. 3 is the blueprint of another method of manufacturing probe pin, FIG. 4 shows completed probe pin rolled into cylindrical shape, FIG. 5 shows ongoing test commenced by contact between socket and IC chip. FIG. 6 shows step by step manufacturing method of socket assembly and FIG. 7 shows process of heat and punching transforming bump and latch surrounding area of pin hole.

One-piece socket (200) is located between IC chip (100) and main board (300). The invention consists of one-piece socket (200), which has numerous pin holes (210) above main board (300), and probe pin (240) with constant elasticity inserted inside pin hole (210).

As shown in FIGS. 2 and 4, probe pin (240) includes upper contact part (241), lower contact part (243), and middle elasticity part (242). Upper contact part (241) comes in contact with IC chip (100) and lower contact part (243) comes in contact with main board (300). Also, middle elasticity part (242) made with wire spring in form of zigzag connects upper contact part (241) and lower contact part (243).

Upper contact part (241), middle elasticity part (242), and lower contact part (243) of probe pin (240) are connected vertically to form flat board. The flat board is reeled into cylindrical shape when two opposite ends of the flat board come in contact. It is important that probe pin (240) is made out of conductor high in conductivity and elasticity and socket (200) is made out of insulator or nonconductor.

Therefore, vertical elasticity of probe pin (240) prevents contact failure by improving binding force of IC chip (100) and main board (300).

Also, probe pin (240) of one-piece socket (200) includes upper latch (220) and lower latch (230).

Upper latch (220) guarantees that upper contact part (241) of probe pin (240) doesn't drift up and lower latch (230) guarantees that lower contact part (243) doesn't drift down.

FIG. 6 shows step by step manufacturing method of socket assembly and FIG. 7 shows process of heat and punching transforming bump and latch surrounding area of pin hole. As shown in FIG. 6, when it comes to manufacturing method socket formed between IC chip (100) and main board (300), numerous cylindrically shaped pin holes are formed at socket (200). Next, probe pin (240) is manufactured (S120). Then, probe pin (240) is inserted into pin hole (210) (S130). After probe pin (240) is inserted (S130), as shown in FIG. 7, lower latch (230) is formed to prevent probe pin (240) drifting down.

The content in this disclosure is an example of the appropriate use of the invention. Therefore, all the technical content are not included and it should be acknowledged that there may be multiple designs to replace it. It is important to point out that the invention is not restricted to the example mentioned. Also, as people with knowledge of the field where the invention belongs to can make different variations, any kind of variation of the invention will be within claim of this invention.

### REFERENCE NUMERALS

100: IC chip
200: One-piece socket
210: pin hole
220: upper
230: lower
240: probe pin
241: upper contact part
242: middle elasticity part
243: lower contact part
250: solder ball
300: main board

1. A method of manufacturing a socket assembly between an integrated circuit (IC) chip and a main board, the method comprising steps for:
forming a plural pin holes in a socket;
forming probe pins by cylindrically rolling both end portions of a flat board to contact each other;
forming a upper latch at a upper portion of each pin holes in order to prevent the probe pins from pulling out of socket;
forming a vertical protrusion on the bottom portion of a circumference surface of the pin holes;
inserting the probe pins into the pin holes; and
forming a lower latch applying heat and punching to vertical protruded bump or surrounding area of socket to form latch around lower part of pin hole, preventing probe pin from drifting down from the socket.
